(19) United States
(12) Patent Application Publication
(10) Pub. No.: US 2012/0253932 A1
(43) Pub. Date: Oct. 4, 2012

(54) Method and System for Fundraising for Member-Based Organizations

(76) Inventors: Stanley Kim, San Diego, CA (US); Fred Clarke, Bellevue, WA (US)

(21) Appl. No.: 13/431,899

(22) Filed: Mar. 27, 2012

Related U.S. Application Data
(60) Provisional application No. 61/471,128, filed on Apr. 2, 2011.

(51) Int. Cl. G06Q 30/02; G06Q 30/06

(52) U.S. Cl. 705/14.53; 705/14.66

(57) ABSTRACT

The present disclosure provides a system and method for generating fundraising revenues for member-based entities. In a more preferred embodiment, there comprises an online fundraising system and method for providing relevant promotions to members of an entity, such as a non-profit, charitable institution, church or school.

### CROSS REFERENCE TO RELATED APPLICATIONS

This application claims the benefit under 35 U.S.C. §119(e) to U.S. Provisional Application Ser. No. 61/471,128 filed Apr. 2, 2011.

### FIELD OF THE INVENTION

The present disclosure provides a system and method for generating fundraising revenues for member-based entities. In a more preferred embodiment, there comprises an online fundraising system and method for providing relevant promotions to members of an entity, such as a non-profit, charitable institution, church or school.

### SUMMARY OF THE INVENTION

The present disclosure provides a system and method for collectively aggregating promotions or advertisements and selectively distributing the promotions or advertisements to a network of recipients to generate funds or revenues. In a more preferred embodiment, there comprises an online collective promotions network and method for providing relevant promotions to members of an entity, particularly to a non-profit, charitable institution or school, or school organization. Preferably, such promotions are derived by pairing the distinguishable characteristics of the members of the entity with the target characteristics of the vendor, such characteristics include geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), affiliations or relationships (such as membership, alumnus status, parent, grandparent, sibling or other relationship) and the like. As described herein, fundraising refers to for-profit or non-profit, charitable or non-monetary, activities that benefit one or more recipients. The funds or revenue that are generated from vendors can be all or a portion of the funds or revenues generated from a vendor.

### BRIEF DESCRIPTION OF THE DRAWINGS

FIG. 1 is a schematic flow diagram of a fundraising system and method for providing relevant promotions to a member-based entity.

FIG. 2 is a diagram illustrating portals for activating the system pursuant to a user's (or registrant's) initiation of a transaction.

FIG. 3 is a schematic flow diagram for a subsystem for offering promotions derived by pairing the distinguishable characteristics of the members of the entity with the target characteristics of the vendor

FIG. 4 is a diagram of a fundraising system and method to coordinate information within the system.

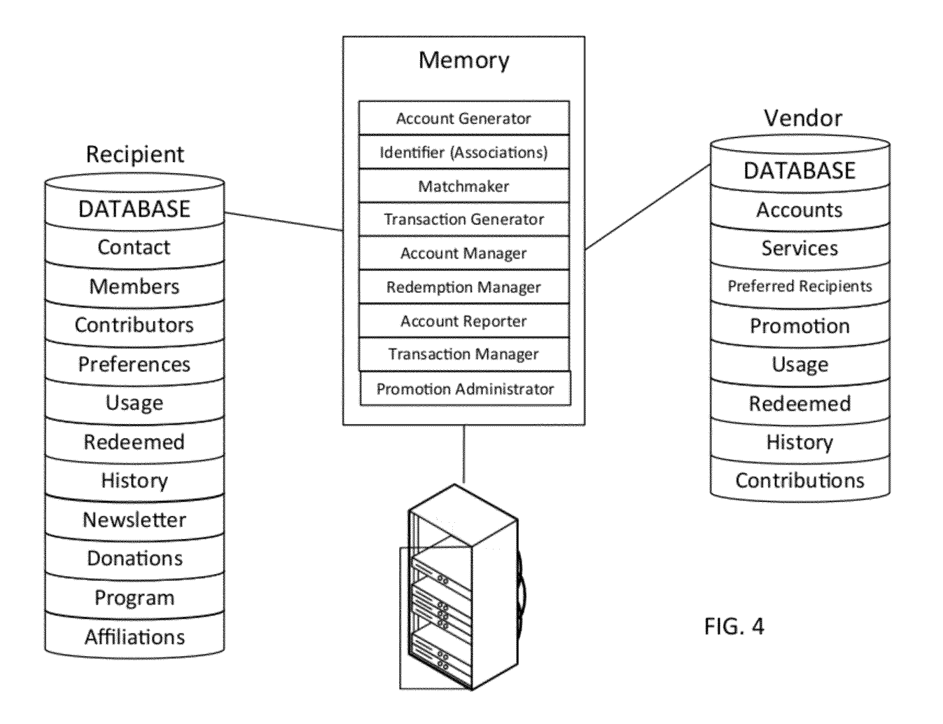

FIG. 5 is a diagram for active A-B testing of different promotions to various members of an entity.

FIG. 6 illustrates a system and a method for assaying active purchasing behavior.

FIG. 7 illustrates a method or system for enhancing the value of promotions by allocating promotions temporally, geographically or by frequency.

FIG. 8 illustrates the collective aggregation of vendors and/or promotions/advertisement stored on a database that are allocated to recipient network based on matched characteristics.

FIG. 9 shows recipient webpage displaying potential vendors, vendors chosen in Queue, and additional vendor information requests.

FIG. 10 shows a user (in this example, a business, although also appropriate for the organization) to identify and choose suitable or desirable partners within a certain range from the user.

### DETAILED DESCRIPTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well-known features may not have been described in detail to avoid unnecessarily obscuring the invention.

The present disclosure provides a system and method for collectively aggregating promotions or advertisements and selectively distributing the promotions or advertisements to a network of recipients, e.g., member-based entities, to generate funds or revenues. In a more preferred embodiment, there comprises an online collective promotions network and method for providing relevant promotions to members of an entity, particularly to a non-profit, charitable institution or school, or school organization. In an alternate embodiment, there are provided a method and system for matching vendors and promotions/advertisements with a network of member-based entities, comprising collectively aggregating vendors and promotions/advertising through a network of member-based entities and matching member-based entities with suitable promotions. Preferably, such promotions are derived by pairing the distinguishable characteristics of the members of the entity with the target characteristics of the vendor, such characteristics include geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), affiliations or relationships (such as membership, alumnus status, parent, grandparent, sibling or other relationship) and the like. As described herein, fundraising refers to for-profit or non-profit, charitable or non-monetary, activities that benefit one or more recipients. The funds or revenue that are generated from vendors can be all or a portion of the funds or revenues generated from a vendor.

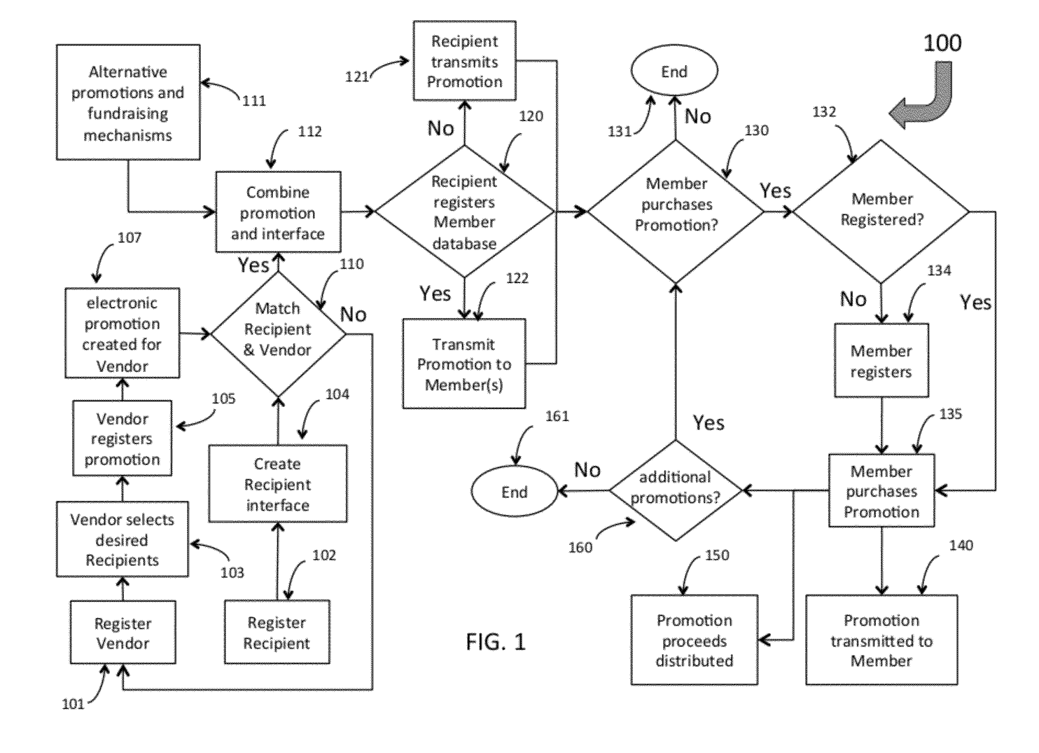

FIG. 1 illustrates a system 100 for collectively aggregating promotions and selectively distributing the promotions to a network of recipients. The preferred present invention contemplates a fundraising mechanism for entities to generate revenues through the proactive registration and matching of vendors and the recipients of all or some of such funding. Preferably, such system is adaptive, more preferably self-adaptive. As illustrated in FIG. 1, vendors such as businesses, service providers, shops, manufacturers, restaurants, and the like will register 101 with the system 100. Through the registration process, certain identifying characteristics will be identified such as location and, optionally, target customers, of vendor, which can be used to characterize potential partner recipients. General information about the vendor can be used to generate a “picture” of the vendor to be used to promote vendor in system. Such information can include images or descriptions, including name, address, product or service provided, affiliations such as alumni status or relationships (e.g., parent of child at school or organization), membership, interest, demographic member, location or proximity, business interest, or other such information, or other such distinguishable characteristic (as described above). Preferably, vendor may expressly identify particular target recipients 103, such as local schools, non-profits or charitable organizations. Recipients of the fundraising system can also be other organizations with fixed memberships and/or other engaged patronage. Most preferably, the system 100 will identify specific potential target recipients in proximity to vendor, identify a class or pool of potential target recipients in proximity to vendor for vendor to choose amongst, and/or request vendor to identify characteristics of potential target recipients.

Preferably, a plurality of vendors choose to participate in a fundraising system. Upon registration, each vendor will submit one or more potential promotions for distribution 105. The promotions and deals preferably include any manner in which the vendors believe they can generate revenues directly or indirectly from consumers for services or purchases which can be donated, acquired, distributed or shared with participating recipients, including, but not limited to, sales incentives, rebates, vouchers, redeemable gift certificates, coupons, advertisements, raffles, auctions, freebies, discounts, and the like, and particularly include sales incentives such as BOGO (or Buy One (or more) Get One (or more)), discounted gift certificates, discounted coupons, matching programs (e.g., dollar for dollar), in-kind services, and the like. An electronic representation 107 of such promotions can automatically or manually be created by the system 100, e.g., by a promotion template filled in by the vendor or other party. In addition, multiple promotions can be input into the system for each vendor.

The promotion preferably includes at a minimum such terms as are legally sufficient to define the offer that a transactions represents, or more generally a description to suffice as an advertisement. Accordingly, offer information may, and usually will include such information as a product description and/or the price and/or discount to be applied, maximum and/or minimum value, exclusions, vendor description, etc. If the transaction is for entry or admission for an event or venue, the relevant information in the promotion can include the purchase price, the date, and the name or identifier for the event or venue. If only certain merchants or locations will honor an offer, for example, specific franchisees, that information also will be included. Offer information also may include expiration dates, limits, and other terms and conditions imposed by a vendor. In addition to information supplied by the vendor, the system may generate information to assist in the prosecution of the promotion. For example, the system may generate or include a transaction identifier that may be unique to a particular recipient and/or member, transaction or transaction type, the vendor, and the like. The system may also generate offer codes to assist in tracking the effectiveness of campaign, and usually will include such codes if a manufacturer, franchisor, or other third party will reimburse a vendor who honors the electronic transaction. System may also comprise a guide, wizard or template for vendors to input promotions.

In parallel, not necessarily simultaneously, recipients requesting funding will register with the system 102 providing its contact information, address, representative of entity, method of preferred payment and other payment account, etc. Recipients contemplated by the present invention include organizations or entities with fixed distribution lists such as membership lists, which include schools, school organizations, non-profits and charitable organizations. Upon registration, recipient will have the option to create a customized interface for its fundraising 104 or to use the standard system interface 104. Preferably, a customized interface is prepared initially and maintained through a template that is customizable to and for recipient requiring minimum input from recipient, e.g., URL, logo, color choice, pattern, photos and other images, and the like. Alternatively, the interface is based on existing web templates unique to recipient. The interface can be used as a primary or secondary site for recipient, or as an alternate or complementary site. Preferably, the interface can be the template for the recipient to promote the promotion 112. It can also be used as a template for the recipient to provide information about the recipient, e.g., as the primary website or as an electronic newsletter or flyer. Such information can be manually input or autogenerated. In addition to the promotion, the interface can be used to promote additional alternative promotions or fundraising mechanisms 111, such as auctions, raffles, and advertisements or for programs, such as reading and math programs for schools and parents.

As further illustrated in FIG. 1, recipient will be matched with vendor and/or promotion 110. Preferably, promotion will be automatically selected by the system based on location of vendor and recipient. Alternatively, or in addition to location, selection is predetermined based on the registration requests of both parties. Depending on the recipient, an administrator for the recipient may select each vendor and/or promotion, or disqualify certain vendors, promotions, industries, vendor groups, etc., e.g., certain entities such as schools may not desire liquor stores to participate in their pool of vendors. Most preferably, vendors will register with certain recipients added as their pool of potential recipients, and in parallel, recipients will register with certain vendors or classes of vendors be added as their pool of potential vendors. If vendors with promotions are already registered in the system when recipient registers or requests additional promotions, recipient can select those specific vendors and/or promotions it will qualify or disqualify as recipient's selected vendors. If there are no matches, for example, there are no suitable vendors or promotions suitable in the system, the system will wait until a suitable promotion is available, whereupon the promotion will be integrated into the recipient's interface. In yet another alternative, or in addition, promotions can be weighted by other factors, such as for example, by the members, e.g., a list of promotions can be voted or chosen by members.

Promotion can be distributed directly or indirectly by the system. Preferably, recipient can provide or upload contact information for its members or its distribution list to the system 120. System can transmit the promotion to recipient through a multitude of platforms 122, including email, SMS or other text message, twitter or other electronic message. It will be appreciated that the offer or promotion can be presented to user in a variety of means, including verbal, telephonic, TV or radio, mobile, electronic or written, including such methods as email, text, flyers, requests, social media tools, newsletters, advertisements, and the like. Generally, however, many recipients are hesitant to release their membership or distribution list, and prefer to send out any information to their members directly. Accordingly, in one preferred embodiment, recipient can directly send promotion information to its members and affiliates 121. This information can be sent intact, in summary (or certain portions of the promotion such as the vendor, type, discount, etc.) or represented, for example, as a website address or link directed to the promotion. Alternatively, many recipients may not have the means and resources for transmitting electronic promotions, and would require the system to transmit promotions. Preferably, the system contemplates storing recipient member information on the system.

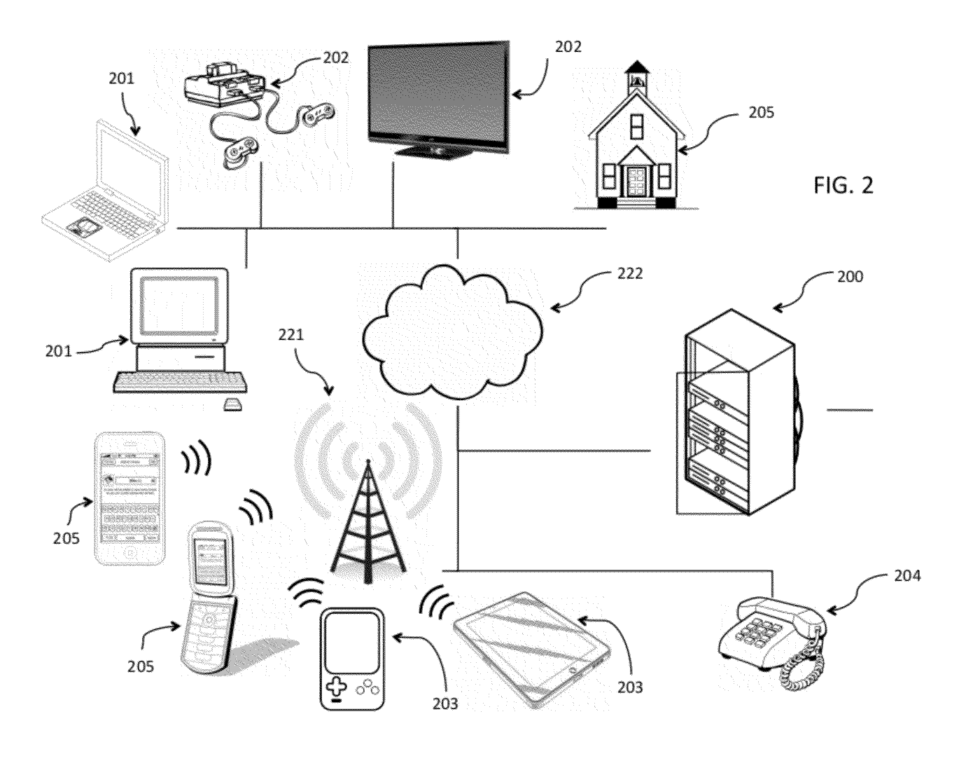

It should be noted that various aspects of transmitting the promotion may be implemented using any of a wide variety of communication devices and computing platforms, in any of a variety of network types (or combinations thereof), and in any of a wide variety of contexts in which the issuance of electronic promotions are useful functionalities. For example and as illustrated in FIG. 2, implementations are contemplated in which electronic promotions may be issued, and users and providers may interact with the fundraising system using personal computers 201, media computing platforms 202 (e.g., gaming platforms, or cable and satellite set top boxes with navigation and recording capabilities), handheld computing devices (e.g., PDAs or handheld gaming platforms) 203, conventional land lines 204 (wired and wireless), mobile (e.g., cell or smart) phones 205, or any other type of portable communication or computing platform (e.g., vehicle navigation systems). Such promotions may be resident on some of these devices, e.g., in connection with a browser, messaging, or other application, or be served up from a remote site, e.g., in a web page or a messaging application. In addition, a fundraising system 110 (represented by server and data store) may be accessible to the various types of devices either directly or indirectly via a wide variety and/or combination of network environments and protocols (represented by network 222) including, but not limited to, TCP/IP-based networks, plain old telephone system (POTS) networks, telecommunications networks, wireless networks, satellite networks, etc. There might also be 3rd party systems also contemplated which might issue transactions using APIs to access the relevant data.

An exemplary system 100 according to the present invention consists of a server 200. Server 200 may be implemented, for example, by using a general-purpose computer or a personal computer. Server may be connected to a network, such as one or more of a local area network (LAN), a wide area network (WAN), and the Internet. Server generally includes a database of consumer profiles, a database of recipient profiles, a database of vendor profiles, an affiliation database, a promotions database, a communication gateway, an authorization and queue application, and the like. Optionally, server may contain additional features such as a database of potential consumers, non-profits or schools, businesses, manufacturers; financial tools, a customer relationship manager (CRM), a neural network or other data-mining tools to extract information from the server. Alternatively or additionally, server may access another server or other processing or memory means for any or all of these functions or features. Server may be accessed by a web interface. For example, a user may input a mobile phone number in a web banner as a method of initiating a purchase of a mobile device download, for instance a ringtone, game, picture, video, or other download. The account may include billing information. In the event that no previously formed account, the web interface may direct the user to set-up an account, by for instance creating a new web interface or redirecting the existing web interface.

Once the general information of the promotion or the address to the website is transmitted to recipient's members (including constituents, patrons, supporters, beneficiaries, distribution lists, affiliates and the like), the member is presented directly or indirectly with the promotion, including its terms and general information. The member must then decide 130 to ignore/disregard the promotion 131 or to purchase the promotion. As further shown in FIG. 1, the member enters the system 100 through a communication received by the system or the recipient. Preferably, the member will view the promotion that will be generally attributed to the recipient or specifically attributed to the recipient via recipient's website home page on the system, both which provides information on the promotion/vendors and fundraising system. Other pages are also contemplated, for example a login page or other information. If the member decides to accept or purchase the promotion, the member will then proceed with registration 134 in the fundraising system, which will request certain information from the member sufficient to process the transaction (e.g., purchase of the promotion) such as their name, address, phone, financial information and other such information. The system may further request login information such as an ID account and password, as well as confirmation of the beneficiary recipient. Additional information may also be requested. By registering with the system 134, the member can bypass many of the registration process by simply entering the system as a registered user of the system. If the member decides not to register with the system, the process ends. If the member decides to continue registration with the system, the system then attributes the member to the recipient's database. The member may also be presented with additional promotions that the member may agree to accept or decline 160.

As will be appreciated by those in the art, a consumer need not be a member or affiliated with the recipient, but can access the system independently. Upon access, the consumer may be presented with inquiries regarding geographic information, potential recipients and similar questions to route the consumer to a particular recipient.

In a detailed perspective of the present invention, member initiates the transaction process by electronically purchasing 135 (generally purchasing, buying, donating or donated, winning, acquiring, renting, leasing, gifting or gifted, requesting, and the like) an offer for a good, product, service, payment and the like. For example, member may purchase online a coupon for a discount for dinner for a local restaurant advertised or promoted to user. The electronic transaction will register with system and a certain portion of the proceeds received will be attributed and sent to the recipient 150, or a beneficiary designated by the recipient. The proceeds can be sent to recipient by any means customary for recipient to receive funding.

In an exemplary embodiment, the recipient is a recipient school (or it's representative such as PTA or Educational Foundation or booster) that informs and promotes to its students, teachers, parents, and general community that it is signed up with the fundraising system. The recipient school preferably offers to the students, teachers, parents, and general community a promotion through a web site. Parents, relatives, and members of the community preferably visit the web site of the system and decide to participate in the fund raising system 100 by registering with the site 134. After registering 134, the parents, relatives, and community member become participants designated to a school or schools. Alternatively, a prospective participant can identify a particular school by entering such information as the state, city, school district, or particular school for which the participant desires to donate money to. The participant can view information about promotions and vendors on the system, and then determine whether to proceed with transacting the promotion. The recipient can also be an organization such as sporting team, club or other similar organization within a larger recipient.

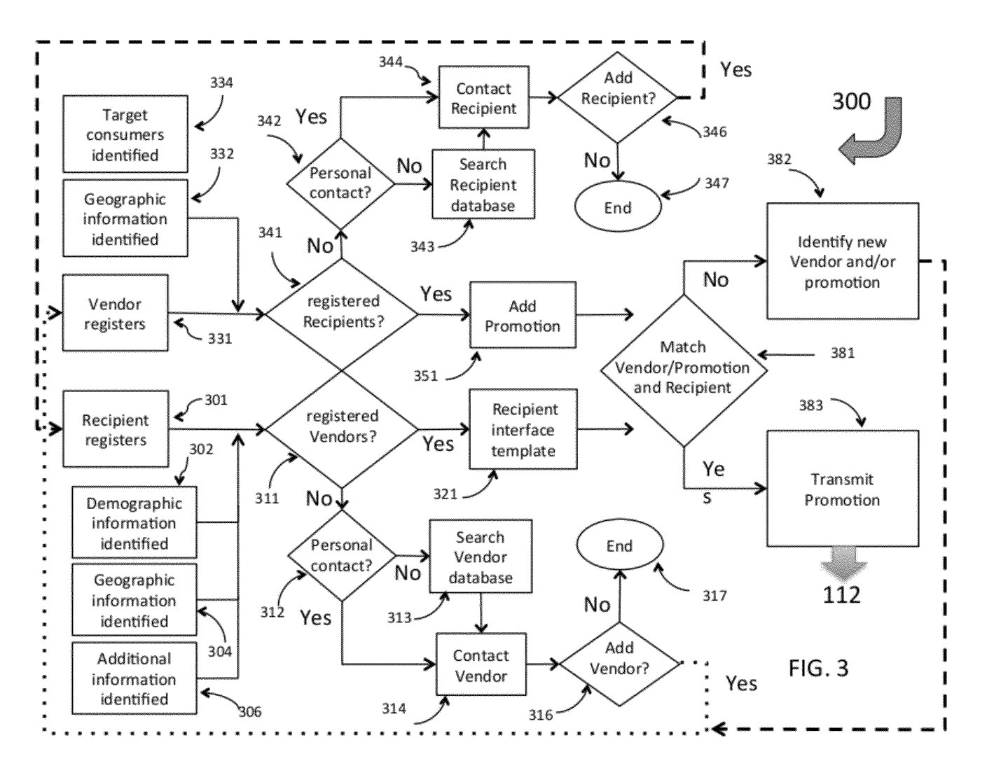

In a preferred embodiment, vendors will desire to promote certain transactions or promotions to particular recipients based on recipients and vendors location, vendor's ties to a recipient (e.g., a parent of a child in a particular school system or a member of a non-profit), vendor's target demographics (e.g., an ice cream store for schools), and the like. Accordingly, FIG. 3 illustrates a particular feature of the present invention of pairing vendors and recipients, particularly based on targeted marketing characteristics such as affiliations, geographic segmentations (their location) 332/304, demographic/socio-economic segmentation 302 (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), and the like 306/334. As recipients and vendors register with the system 301 and 331, certain characteristics are inquired and/or identified of the vendor and recipient, respectively. The system will identify potential partner recipients (for vendors) and vendors (for recipients) that may or may not be registered in the system. Preferably, the system will include a database of existing vendors and recipients, minimally preferably, recipients (e.g., non-profit database, school database, etc.).

If the respective partner is not registered in the system 311/341, irrespective of whether the general information about the respective vendor and recipient is in the system, the system may request for personal connections to the respective partner (i.e., vendors to recipients 312 and recipients to vendors 342). The system may directly contact the recipient 344 and/or vendor 314 or may search within its database for contact information regarding the respective recipient 343 and/or vendor 313, to request recipient and/or vendor join the fundraising system or provide information regarding the fundraising system. The recipient 346 and/or vendor 316 can then determine whether to accept or decline 317/347 registration. Additional recipients and/or vendors can be added through the system by this process.

If the respective partners are registered, vendors can continue to process their promotions 351 and general information, and recipients can continue to process their general information, databases and, optionally, their interface template for promotions 321. As further illustrated in FIG. 3, the system will then confirm the pairing of the vendor and/or promotion with the recipient 381. As discussed above, there may be occasions where certain potential partners, particularly recipients, do not want to be associated with particular vendors and/or promotions. If a pair is matched, the promotion can be broadcast to recipient's members 383. If a match is not made or declined, then new pairings are identified 382.

As illustrated in FIG. 3, the system is developed to more efficiently identify partner vendors and recipients. Preferably, the first registrant can be a recipient, a vendor or a consumer associated with either of the two, who will help develop the counterpart partners in the system through a series of feedback loops to identify potential new partner vendors and recipients.

In one preferred embodiment, the system preferably includes a database for storing information that can be valuable for communication with the recipients and their members (constituents, patrons, donors, distribution lists, affiliates and the like) with the vendors participating in the fundraising system, and any affiliations between the two. For example, the database can store school information such as logistical data as the state, city, zip code and school district in which the participant school is located to compare against vendors in the same location.

The database preferably also includes vendor information. The vendor information preferably includes general information regarding businesses, such as industries, locations, target demographics, sales, prior promotions, employees or authorized users, and the like. As vendors utilize the system, information typically stored in the vendor information of the server database, for example, can include such information as promotional sales incentives and deals that are setup between the system and the vendors for contributions to participating recipients within the fundraising system. The promotions and deals preferably include any manner in which the vendors believe they can contribute to the participating recipients which include, but are not limited to, accepting predetermined dollar amounts added to bills for services provided, donating a portion of each purchase to the participating recipients, donating a specific amount per members/users making a purchase with a redeemable coupon, or merely providing a better or reduced price for members/users within the community to help participating recipients.

The vendor database may also include administrative management tools to provide statistical information regarding the value of specific promotions, purchase history and trends, tracking of redeemed transactions such as redeemed discounts and coupons that are taken advantage of by consumers, and an overall usage by recipients and vendors of the fundraising system. The statistical information stored within the vendor database provides data to show what promotional sales incentives the members are utilizing for saving money for the participating recipients with the fundraising system. The database also advantageously provides overall historical background for the vendor to appreciate additional business created with participating recipients through the fundraising system.

The system preferably also includes a database that stores general information of recipients. The recipient information preferably includes general information about recipient and its members such as location such as city, state, zip code and regional affiliations (e.g., school districts), type of organization (e.g., non-profit, school or charitable organization, and more specifically e.g., primary or secondary school, law enforcement foundation, environmental group, church, etc.), general characteristics of members (e.g., parents of elementary schools, donors of non-profit, members of church, parents of school band, etc.), specific membership information such as member contact information (e.g., email, cell phone, social media contact information such as Twitter or Facebook or such other information), and the like.

The system also preferably stores transaction information pertaining to the fundraising system. Information relevant to the vendor such as purchased transactions, redeemed transactions, statistical information such as most fruitful transaction, demographics information, and the like may be tracked and viewed by vendor through a specific portal created for each vendor. Similarly, similar portals can be created for recipients, their members or other consumers registered with the site with respect to their transaction information and related statistics relevant to each entity. For example, the typical donation data stored within the system can include, but is not limited to, the amount donated to each recipient and the amount of money donated from each vendor through the fundraising system. The statistical information found in the donation data 339 can advantageously be used by the fundraising system to provide information to the recipient, their members, and the vendors 611, to show how the fundraising system 111 is working within the community to raise or save money for the recipient (and its members) through the efforts of the participating members and the vendors.

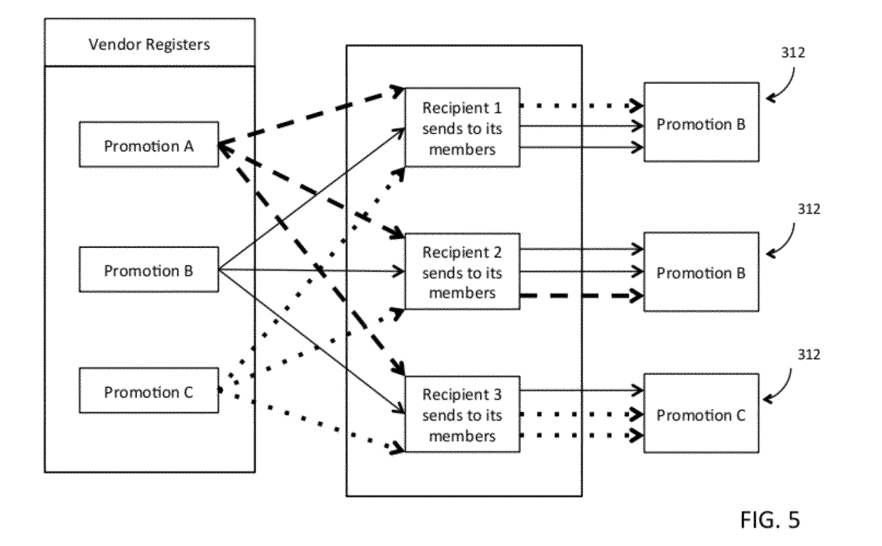

FIG. 5 illustrates a method or system for actively identifying consumer preferences or trends. Many marketing systems are available that identify consumer information such as location and demographics upon the purchase of a product or service. Such data mining tools are readily available to mine, for example, the credit card purchasing habits of an individual based on their marketing target characteristics such as location, demographics, etc. Very few tools actively test the purchasing habits of consumers by actively promoting multiple promotions, and learning behavior as they relate to the consumers affiliations with a particular organization (e.g., a recipient) and the recipients characteristics. Accordingly, the present invention further, as shown in FIG. 5, describes a method and system for actively testing consumer behavior, preferences and trends based on affiliations to an organization. FIG. 5 describes a system and method for assaying multiple promotions from a vendor(s) presented to multiple consumers (generally as they are affiliated with a particular recipient or a group of recipients). Alternatively, multiple promotions (same or similar can be from different vendors). Preferably, the promotions are closely related such as from the same vendor, same type of service or product, location, generally the same deal packaged in multiple ways (e.g., $50 for $100 of services or 50% discount for $100 or Buy One $50 certificate Get One $50 certificate free), different colors, or such other closely related yet trackable promotions. Preferably, the promotions are different in one characteristic or another. More preferably, the promotions are for services.

As further described in FIG. 5, a panel of promotions are each sent to multiple consumer pools or a group of consumers. Preferably, the consumers are based on their affiliations with a particular recipient. The promotions can be sent at the same time or at differing times. Although the purchasing history of each individual can be measured, in order to preserve individual privacy rights, the system will preferably gather aggregate information for the pool of consumers. The purchases and non-purchases are then aggregated and analyzed to determine spending preferences for each pool. This information is compared against other information about the pool of consumers and recipients, such as geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), and the like to determine marketing and trend information for the pool of consumers. For example, different purchasing habits of parents can be determined based for each school, affects of donation as a motivation for non-profits in comparison to discounts, comfortable spending levels for different communities, as well as such understanding such statistics and analytics over time.

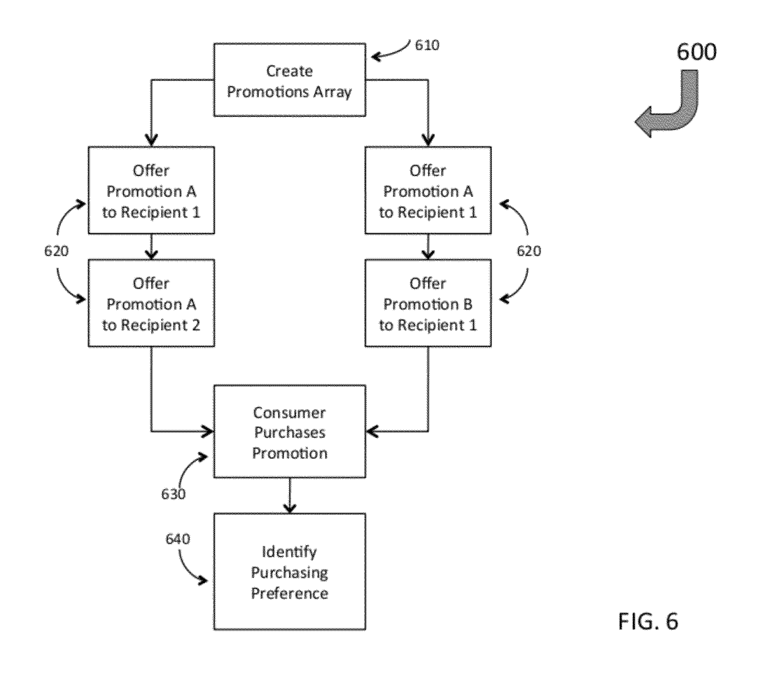

Preferably, as shown in FIG. 6, there is provided a method for assaying active purchasing behavior. From a pool of promotions 610, similar offers are prepared for multiple recipients with common or overlapping characteristics such as interests, members, geographic location (for the recipient or it's members), demographics or other target characteristics; or alternatively, different offers are prepared for the same recipient. Recipient(s) transmits the promotions 620, whereupon the purchase of the promotions by the consumers are recorded 630, and analyzed to determine preference, behavior and/or trends 640, and then further analyzed in comparison to the characteristics of the recipient.

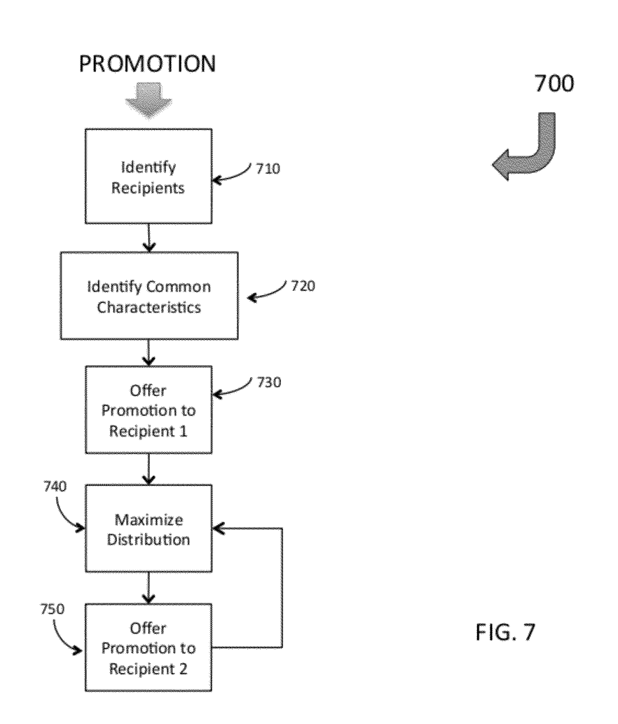

An alternate view of FIG. 5 illustrates a method or system for enhancing the value of promotions by allocating promotions temporally, geographically or by frequency. Members or other consumers of a distribution list for a recipient may inherently be affiliated with more than one recipient. Vendors may desire to allocate promotions to consumers over a large area, or longer period of time. For example, a parent (i.e., member) of a school may have multiple children at different schools within close proximity of each other. It may be favorable to distribute the promotion to each of the schools over a year to enable multiple recipients to offer the same or similar promotions (and accordingly receive any associated fundraising amounts) and to increase the effectiveness of the promotion. Alternatively, it may be preferable to allocate promotions to an organization within a larger recipient and a distinct recipient, then reintroduced to the larger recipient at a different time so as to reduce competition of the promotion. Preferably, as shown in FIG. 7, this can be accomplished by identifying each recipient 710 for each vendor and/or promotion, identifying common denominators and characteristics 720 such as geographical overlap for the group of recipients, and maximizing the distribution (temporally, spatially or frequency, or such other limiting tools such as expiration dates) 740 of the promotion to affect the most number of recipients 730 and 750 and/or reduce inundation of the promotion.

It will be much appreciated by those of skill in the art, the present invention can be more broadly applied to other recipients beyond non-profits, charities and schools such as individuals, organizations, corporations and companies, and other such entities that are looking for revenue or funds.

In yet an alternative preferred embodiment of the present invention, the present disclosure provides a system and method for a collective ad network. In a more preferred embodiment, there comprises an online system and method for several organizations to collectively generate revenues, wherein each organization provides an ad or promotion to the system that is then collectively distributed amongst one or more group members. The promotions or ads are collectively added to a library of ads or promotions. In a preferred embodiment, the system is automated to identify which ads or promotions can be shared amongst the group through distinguishable characteristics of the members of the organization with the target characteristics of the ad or promotion, such characteristics include geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), and the like.

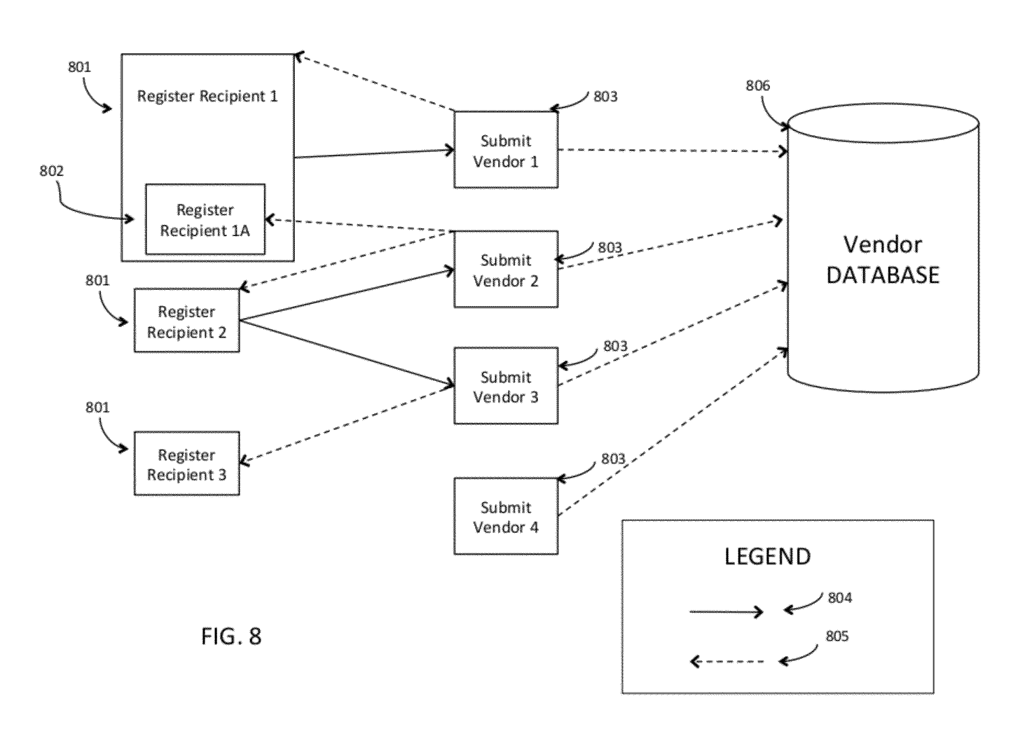

FIG. 8 illustrates the invention system that collectively aggregates vendors and/or promotions through a network of recipients 801, which are then selectively allocated to recipients with common characteristics. Such common characteristics include geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), and the like. As shown in FIG. 8, one or more recipient 801 (such as an individual, organization, corporation or other such entity; or a sub-entity or subgroup within a larger organization 802) registers with the system. During the registration, recipient is asked questions to gather or learn characteristic information, or alternatively, such information can be acquired through a pre-existing database or library. Preferably, system will identify further characteristics about recipient and its members through their usage of the system. The registrant will likely be a representative member for the entity and will answer on behalf of the entity. During the process, system identifies characteristics that are common amongst two or more of recipients such as location, demographic similarities of members, purchasing or use habits of members, or other commonalities.

Vendors are presented to recipient. Preferably, vendors are chosen by the invention system automatically and presented to recipient to choose or not choose as recommendations. As described above, vendor 803 can be automatically invited through social media tools, by personal reference or invite by recipient or by such other mechanisms to invite vendors. Alternatively, vendor can self-register or incorporated into system by an external library or database. Vendor 803 (and promotion) is collectively downloaded to system database 805, which is then available to the network of recipients 801. Preferably, system automatically recommends suitable vendors 803 and/or promotions to recipients that have common characteristic. Recommendations can be made based on requests by recipients of certain vendors, classes of promotions, industry, purchasing habits of members, characteristics of vendor and/or recipient, or such other method as further described herein. Other considerations also include the duplication of promotions or types of promotions so as to minimize competition or redundancy. For example, subgroups 802 within a larger organization 803 (such as sporting teams and clubs within a larger school) will be provided distinctly discrete promotions and/or vendors, or types of promotions/vendors to minimize competitive redundancy. Such choices may consider frequency, spatial (e.g., location) or temporal (e.g., expiration dates or last time offered) characteristics of promotions to maximize independence or differences of promotions. By aggregating the vendors and/or promotions, system collectively and more preferably, automates the processing and collection of advertisements/promotions, and more importantly, as shown in FIG. 8, amplifies the efforts of each recipient 804 by collectively, and preferably automatically, redistributing promotions 805 to one or more recipients.

Preferably, the system will automatically distribute promotions to recipients. Such methods can be based on simple pairing of requests by recipients and/or vendors, matching of characteristics identified by system or provided by recipients/vendors or via a database or such other pattern matching systems, machine learning or pattern recognition systems, and the like. Pattern matching systems include . Pattern recognition algorithms include classification algorithms (supervised algorithms predicting categorical labels), clustering algorithms, regression algorithms, categorical sequence labeling algorithms, real-valued sequence labeling algorithms, parsing algorithms, general algorithms for predicting arbitrarily-structured labels, ensemble learning algorithms, and the like. Machine learning algorithms include decision tree learning, association rule learning, artificial neural networks, genetic programming, inductive logic programming, support vector machines, clustering, bayesian networks, reinforcement learning, representation learning, and the like.

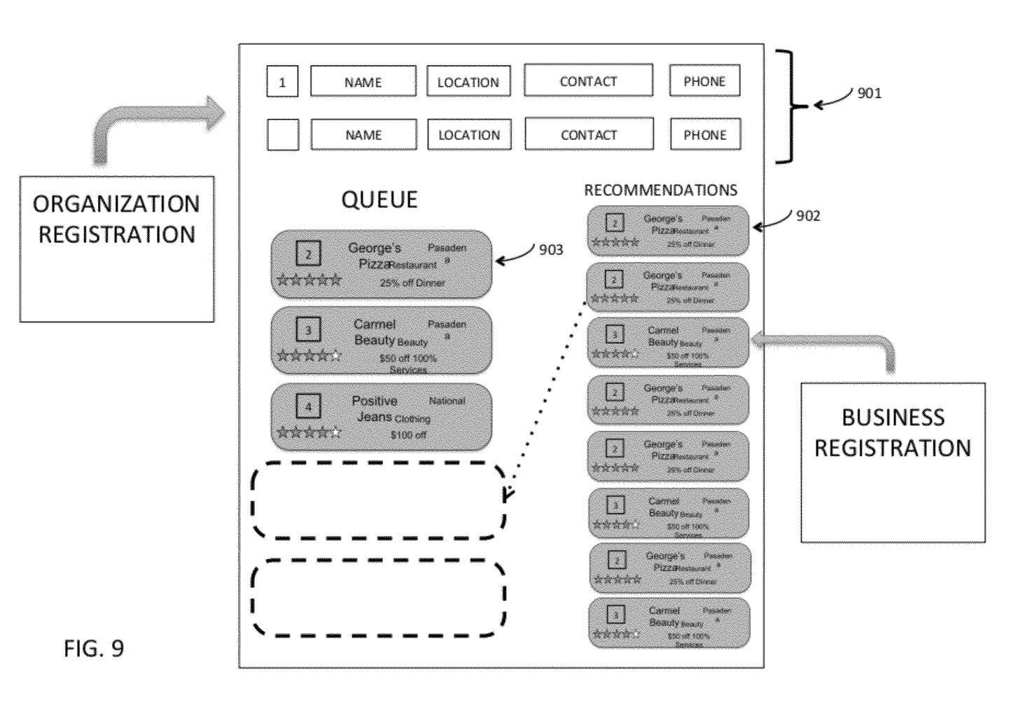

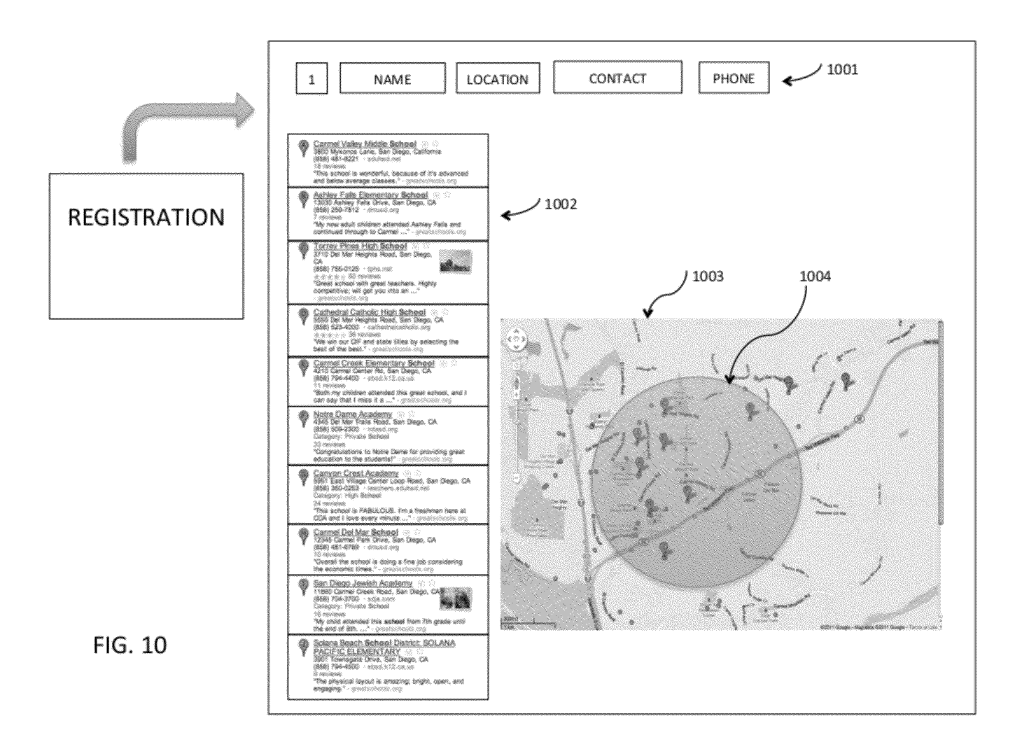

Preferably, recipient 801 is provided the option to select desired vendors 803, preferably through an automated queue system as shown in FIG. 9. System will query 901 recipient to identify potential vendors 902 who may be interested in participating, and/or will alternatively be provided a list of recommended vendors in system database 902. Potential vendors 902 can be automatically invited by system to participate through email, mail, phone or other invitation. Recipient is provided information about vendors 902 and/or promotions, specifically about the businesses, advertisers, promotions, advertisements, recommendations, ratings, type of business, location, etc. recipient then creates a queue of upcoming vendors/promotions 903 for recipient to utilize which can be easily added and removed by dragging and dropping from the recommendation list 902. Recipient's choices can be stored and analyzed to further learn recipient's preference. In one such embodiment, the system is analogous to the system used to pick and store movie choices in a queue, wherein the present invention would have vendors identifying desirable partner entity/organizations and the entity/organization choosing in their queue desirable vendors and/or promotions. FIG. 10 shows an exemplary registration 1001 of a business for choosing proximal recipients 1002 and 1004 based on a map 1003.

While the invention has been particularly shown and described with reference to specific embodiments thereof, it will be understood by those skilled in the art that changes in the form and details of the disclosed embodiments may be made without departing from the spirit or scope of the invention. For example, embodiments have been described herein with reference to the use of conventional landlines and cellular phones. It will be understood, however, that the invention is not so limited. That is, embodiments are contemplated in which a much wider diversity of communication devices may be employed in various combinations to effect redemption.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A fundraising system for generating revenues for member-based entities, comprising one or more servers having a memory storage device for storing a plurality of vendors and member-based entities and processing means for matching a member-based entity with at least one promotion, wherein such promotions are derived by pairing the distinguishable characteristics of the members of the entity with the target characteristics of the vendor, wherein target characteristics are selected from geographic segmentations, demographic/socio-economic segmentation, psychographic segmentation, behavioral segmentation or product-related segmentation.

2. The system of claim 1, wherein the processing means presents a vendor with a list of entities, and where vendor selects one or more entities to present promotions, and wherein processing means presents an entity with a list of vendors, and where entity selects one ore more vendors, wherein processing means adapts the list of vendors and the list of entities based on the selection by entities and vendors, respectively.

3. The system of claim 2, wherein the system further comprises a registration process means for a vendor to register one or more potential promotions for distribution.

4. The system of claim 2, wherein promotions are collectively aggregated by the system and distributed to a network of entities based on target characteristics.

5. The system of claim 4, wherein distributed promotions are selected and distributed based on location of vendor and recipient.

6. The system of claim 4, wherein distributed promotions are selected based on the registration request by the vendor and recipient.

7. The system of claim 4, wherein distributed promotions are selected by a plurality of members of the entity.

8. The system of claim 4, wherein a promotion is distributed to at least one entity temporally, geographically or by frequency.

9. The system of claim 1, wherein the member-based entity is a non-profit, charitable institution, church or school.

10. The system of claim 1, wherein the promotion is circulated to members by the entity.

11. The system of claim 1, wherein said system further comprises administrative management tools to provide statistical information regarding the value of specific promotions, purchase history and trends, tracking of redeemed transactions, and/or an overall usage by recipients and vendors of the fundraising system

12. A computer-implemented method for actively identifying consumer preferences or trends, comprising actively testing consumer behavior, preferences and trends based on affiliations to an organization, wherein a panel of related promotions are each sent to multiple members affiliated to an organization, comparing purchases between members and aggregating like purchases.

13. The computer-implemented method of claim 2, further comprising offering similar offers prepared for multiple recipients with common or overlapping characteristics such as interests, members, geographic location (for the recipient or it's members), demographics or other target characteristics; or alternatively, different offers are prepared for the same recipient.

14. The computer-implemented method of claim 2, wherein recipient(s) transmits the promotions, whereupon the purchase of the promotions by the consumers are recorded, and analyzed to determine preference, behavior and/or trends, and then further analyzed in comparison to the characteristics of the recipient.

15. A computer-implemented method for enhancing the value of promotions comprising a processing means for allocating promotions temporally, geographically or by frequency, comprising identifying each recipient for each vendor and/or promotion, identifying common denominators and characteristics such as geographical overlap for the group of recipients, and maximizing the distribution (temporally, spatially or frequency) of the promotion to affect the most number of recipients.
